(19) United States
(12) Patent Application Publication
(10) Pub. No.: US 2026/0138834 A1
(43) Pub. Date: May 21, 2026

(54) SECONDARY BATTERY MANUFACTURING DEVICE

(71) Applicant: SK On Co., Ltd., Seoul (KR)

(72) Inventor: Soo Ho CHO, Daejeon (KR)

(21) Appl. No.: 19/386,254

(22) Filed: Nov. 12, 2025

(30) Foreign Application Priority Data
Nov. 19, 2024 (KR) 10-2024-0164932

(51) Int. Cl. B65G 43/00; H01M 10/04

(52) U.S. Cl. CPC B65G 43/00; H01M 10/0404

(57) ABSTRACT

A secondary battery manufacturing device is disclosed. According to one aspect of the present disclosure, there is provided a secondary battery manufacturing device including: a conveyor that transports trays in which battery cells are accommodated; a tray loader that stacks a plurality of trays in multiple stages; and a tray detector that detects a stacking defect of the trays, wherein the tray detector includes: a detector body that is in contact and interferes with the tray in which the stacking defect has occurred to change an arrangement state; a sensor that detects a change in the arrangement state of the detector body; and a locking pin that limits the return of the detector body when the arrangement state of the detector body is changed and maintains the changed arrangement state.

### CROSS-REFERENCE TO RELATED APPLICATION

This application claims priority to and the benefit of Korean Patent Application No. 10-2024-0164932, filed on November 19, 2024, the disclosure of which is incorporated herein by reference in its entirety.

### BACKGROUND

### 1. Field of the Invention

Embodiments of the present disclosure relate to a secondary battery manufacturing device.

### 2. Discussion of Related Art

A secondary battery is one of energy storage means which can be charged and discharged through electrochemical reactions. The secondary battery is widely used in various fields in which electrical energy is used. For example, secondary batteries are widely utilized in the field of mobile devices such as a cell phone, a notebook, a tablet, and the like, and are being explored for wider utilization in the field of transportation means such as vehicles, aircraft, ships, and the like. Further, demand for secondary batteries is also rapidly increasing in the field of energy storage systems (ESSs) for utilizing surplus electricity.

Manufacture of the secondary battery may be achieved through a plurality of process operations. In some process operations, the secondary battery may be transported and handled in a state of being loaded on trays, and the trays may be stacked in multiple stages. Since the multi-stage stacked trays may cause various safety accidents during the process, appropriate caution and handling are required.

### SUMMARY

Embodiments of the present disclosure may provide a secondary battery manufacturing device.

Some embodiments of the present disclosure may provide a secondary battery manufacturing device capable of stacking trays in which battery cells are accommodated in multiple stages and transporting the trays.

Further, some embodiments of the present disclosure may provide a secondary battery manufacturing device capable of preventing safety accidents due to a stacking defect of trays.

In addition, some embodiments of the present disclosure may provide a secondary battery manufacturing device capable of more reliably informing a user or the like of a stacking defect state of trays.

In addition, some embodiments of the present disclosure may provide a secondary battery manufacturing device which may be constructed at relatively low costs while appropriately detecting a stacking defect state of trays.

Some embodiments of the present disclosure may be widely applied in the field of green technologies such as an electric vehicle and a battery charging station as well as solar power generation and wind power generation using batteries. Further, some embodiments of the present disclosure may be used in an eco-friendly electric vehicle, a hybrid vehicle, and the like to prevent climate change by suppressing air pollution and greenhouse gas emissions.

According to one aspect of the present disclosure, there is provided a secondary battery manufacturing device including: a conveyor that transports trays in which battery cells are accommodated; a tray loader that stacks a plurality of trays in multiple stages; and a tray detector that detects a stacking defect of the trays, wherein the tray detector includes: a detector body that comes into contact and interferes with the tray in which the stacking defect has occurred to change an arrangement state; a sensor that detects a change in the arrangement state of the detector body; and a locking pin that limits the return of the detector body when the arrangement state of the detector body is changed and maintains the changed arrangement state.

In some embodiments, a deviation may occur in heights of upper ends of the trays compared to a normal state when the stacking defect occurs, and the detector body may selectively come into contact and interfere with the tray according to the deviation to change the arrangement state.

In some embodiments, the tray loader may include a loader frame in which the conveyor is disposed in an inner region; and a loading unit that is disposed adjacent to the conveyor and stacks the trays in multiple stages through a gripper.

In some embodiments, the detector body may be formed to come into contact and interfere with the tray in which the stacking defect has occurred to rotationally move a certain angle around a hinge shaft.

In some embodiments, the sensor may be formed to detect the rotationally moved detector body and detect the stacking defect of the tray.

In some embodiments, in the tray detector, the hinge shaft may be disposed orthogonal to a transport direction of the conveyor, or the hinge shaft may be disposed parallel to the transport direction of the conveyor.

In some embodiments, the detector body may include a pin-seating groove in which an end portion of the locking pin is disposed to be elastically seated in an initial state.

In some embodiments, the pin-seating groove may be spaced apart from a hinge shaft of the detector body at a certain interval in a radial direction centered on the hinge shaft.

In some embodiments, the detector body may include a locking groove fastened to the locking pin according to the change in the arrangement state of the detector body.

In some embodiments, the locking pin may be elastically supported toward an outer surface of the detector body and may protrude in an elastically supported direction to limit the return of the detector body according to the change in the arrangement state of the detector body.

In some embodiments, the tray detector may include an elastic body that elastically supports the locking pin toward an outer surface of the detector body, and the elastic body may include a compression coil spring that accommodates the locking pin therein.

In some embodiments, in the elastic body, one end portion may be supported on an unlock lever and an opposite end portion corresponding to the one end portion may be supported on a fixed bracket, the unlock lever may be fixedly coupled to the locking pin and elastically supported by the elastic body along with the locking pin, and the locking pin may be movably fastened to the fixed bracket along an operating direction.

In some embodiments, the sensor may include a proximity sensor formed to detect whether the detector body is present in a detection region, and the proximity sensor may include one or more of a magnetic proximity sensor, an optical proximity sensor, an inductive proximity sensor, a capacitive proximity sensor, an ultrasonic proximity sensor, an eddy current proximity sensor, and an infrared proximity sensor.

In some embodiments, a pair of tray detectors may be provided, and the pair of tray detectors may be formed to be disposed spaced apart along a left-right width direction of the tray, and come into contact and interfere with the tray in which the stacking defect has occurred at each corresponding position.

In some embodiments, the detector body may include an extending bracket formed to extend along a left-right width direction of the tray, and the extending bracket may be formed to come into contact and interfere with the tray in which the stacking defect has occurred to rotationally move the detector body around a hinge shaft in a left-right direction.

In some embodiments, the detector body may include an extending bracket formed to extend along a left-right width direction of the tray; a first link arm extending from one end portion of the extending bracket and rotationally movably fastened to a first installation bracket around a hinge shaft; and a second link arm extending from an opposite end portion of the extending bracket and rotationally movably fastened to a second installation bracket around the hinge shaft.

In some embodiments, when the first and second link arms are rotationally moved and thus the arrangement state of the detector body is changed, the locking pin may be formed to be fastened to one of the first and second link arms to limit the return of the detector body.

According to another aspect of the present disclosure, there is provided a tray detector of a secondary battery manufacturing device including: a detector body that comes into contact and interferes with a tray in which a stacking defect has occurred to change an arrangement state of the detector body; a sensor that detects a change in the arrangement state of the detector body; and a locking pin that limits the return of the detector body when the arrangement state of the detector body is changed and maintains the changed arrangement state.

In some embodiments, the detector body may be formed to come into contact and interfere with the tray in which the stacking defect has occurred to rotationally move a certain angle around a hinge shaft, the sensor may be formed to detect the rotationally moved detector body and detect the stacking defect of the tray, and the locking pin may be elastically supported toward an outer surface of the detector body and may protrude in an elastically supported direction according to the rotational movement of the detector body to limit the return of the detector body.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view illustrating a secondary battery manufacturing device according to one embodiment of the present disclosure;

FIGS. 2A to 2C are views illustrating an example of the input and stacking operations of trays in the secondary battery manufacturing device illustrated in FIG. 1;

FIGS. 3A and 3B are drawings illustrating an example of a stacking state of the trays in the secondary battery manufacturing device illustrated in FIG. 1;

FIG. 4 is a schematic front view of the secondary battery manufacturing device illustrated in FIG. 1;

FIG. 5 is a schematic perspective view illustrating a detector body illustrated in FIG. 4 in a separated state;

FIG. 6 is a view illustrating an example of the operation of a tray detector illustrated in FIG. 4;

FIG. 7A is a schematic cross-sectional view illustrating the tray detector in an initial state;

FIG. 7B is a schematic cross-sectional view illustrating the tray detector in a state in which the detector body is rotated;

FIG. 8 is a schematic front view illustrating a modified example of the secondary battery manufacturing device illustrated in FIG. 4;

FIG. 9 is a schematic perspective view illustrating another embodiment of the tray detector illustrated in FIG. 4; and

FIG. 10 is a view illustrating an example of the operation of the tray detector illustrated in FIG. 9.

### DETAILED DESCRIPTION

Hereinafter, the present disclosure will be described in detail with reference to the accompanying drawings. However, this is merely exemplary, and the present disclosure is not limited to the exemplified specific embodiments.

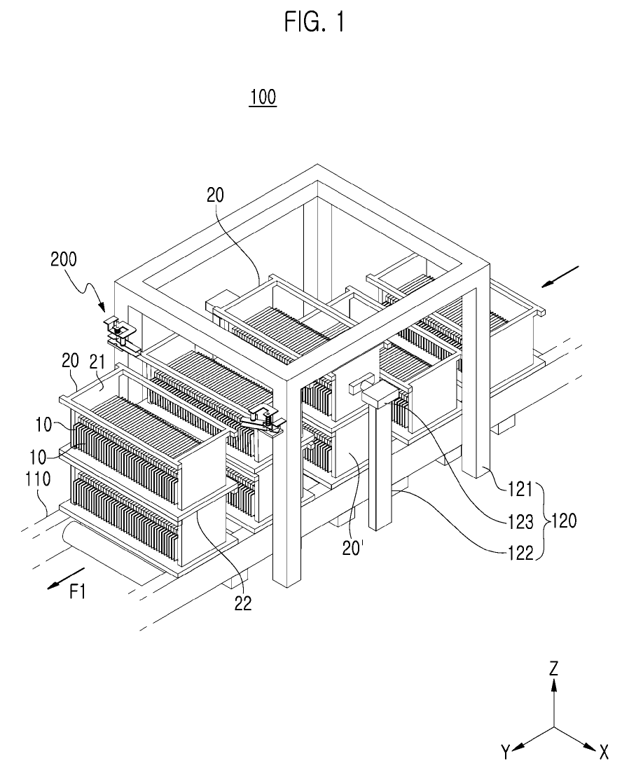

FIG. 1 is a schematic perspective view illustrating a secondary battery manufacturing device according to one embodiment of the present disclosure.

For convenience of description, hereinafter, an X-axis direction is referred to as a left-right direction, a Y-axis direction is referred to as a front-back direction, and a Z-axis direction is referred to as a vertical direction based on the coordinate axes shown in FIG. 1.

Referring to FIG. 1, in some embodiments, a secondary battery manufacturing device 100 may be provided to transport trays 20 in which battery cells 10 are accommodated. The trays 20 may accommodate the battery cells 10 which are being processed or have been processed. However, in the present disclosure, the type, number, and the like of battery cells 10 accommodated in the trays 20 are not specifically limited. For example, the illustrated embodiment exemplifies a case in which a plurality of pouch-type battery cells 10 are accommodated in the trays 20.

In some embodiments, the secondary battery manufacturing device 100 may be provided to stack the trays 20 in multi-stages and transport the trays 20. That is, a plurality of trays 20 may be vertically stacked and transported. The illustrated embodiment exemplifies a case in which two trays 20 are vertically stacked and transported. However, the number of stacked trays 20 may be variously changed as needed, and is not necessarily limited to the example. For example, the trays 20 may be stacked in three or more stages.

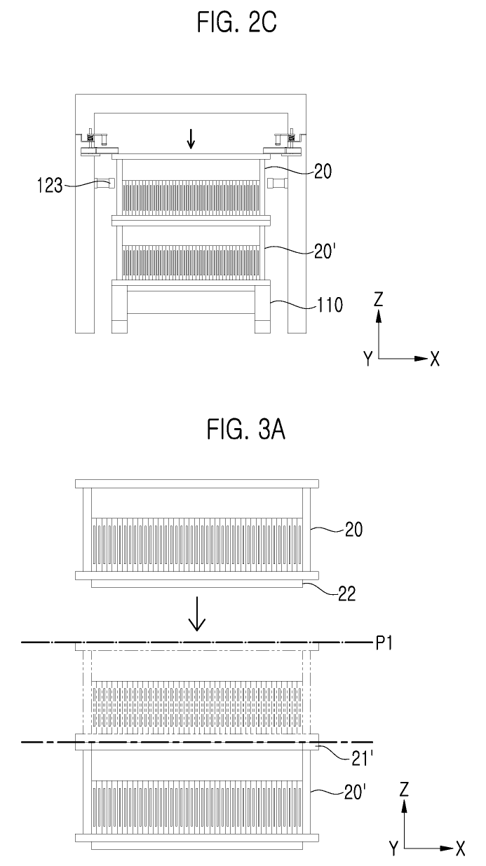

In some embodiments, the tray 20 may include first and second stacking guides 21 and 22 (see FIGS. 3A and 3B). The first and second stacking guides 21 and 22 may provide a coupling structure between adjacent trays 20 so that the plurality of trays 20 may be stacked in multiple stages. Specifically, the first stacking guide 21 may be provided on an upper end of the tray 20 and coupled to the second stacking guide of another tray stacked on an upper side. Further, the second stacking guide 22 may be provided on a lower end of the tray 20 and coupled to the first stacking guide of another tray disposed on a lower side.

The first and second stacking guides 21 and 22 may be provided with various structures, shapes, and the like as long as they can provide an appropriate coupling structure between the stacked trays 20. For example, the first and second stacking guides 21 and 22 may have complementary structures, shapes, and the like which can be engaged and coupled with each other. For example, the first stacking guide 21 may be provided as a structure in a rectangular frame shape whose center region is opened as illustrated, and the second stacking guide 22 may be provided as a structure with a shape protruding from a bottom surface of the tray 20 so that the second stacking guide 22 may be fitted into the above-described rectangular frame shape.

Meanwhile, in some embodiments, the secondary battery manufacturing device 100 may include a conveyor 110. The conveyor 110 may be provided to transport the trays 20 accommodating the battery cells 10 along a transport direction F1. In the illustrated embodiment, the conveyor 110 is formed to extend along the front-back direction and provided to transport the trays 20 from the rear (the right side in the drawing) to the front (the left side in the drawing).

In some embodiments, the secondary battery manufacturing device 100 may include a tray loader 120. The tray loader 120 may be provided to stack the trays 20 transported along the conveyor 110 in multi-stages. In the illustrated embodiment, as the tray loader 120 is provided to lift the tray 20 transported along the conveyor 110 from the conveyor 110, and place the lifted tray 20 on another subsequently transported tray 20' to vertically stack the two trays 20 and 20' in two stages. However, as described above, the number of stacked trays 20 may be variously changed as needed. For example, since an operation method similar to the above is repeated, the trays 20 may be stacked in three or more stages.

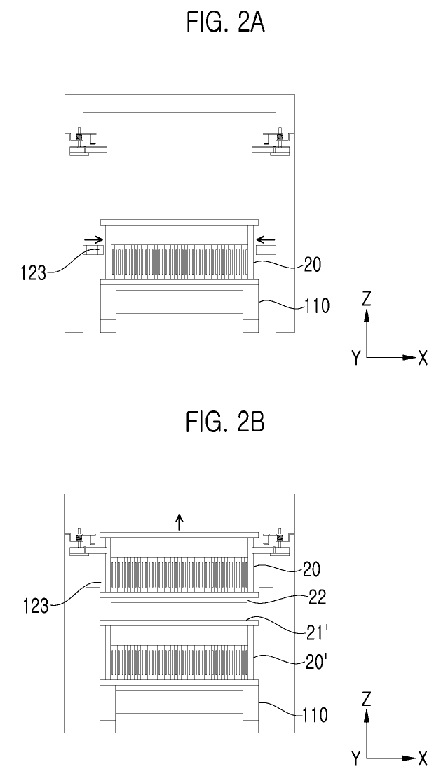

In some embodiments, the tray loader 120 may include a loader frame 121 and a loading unit 122. The loader frame 121 may be formed in a frame structure having a certain shape. Further, the conveyor 110 may be disposed in an inner region of the loader frame 121. In the illustrated embodiment, the conveyor 110 is disposed in an inner lower region of the loader frame 121 and formed to extend in the front-back direction. Meanwhile, the loading unit 122 may be disposed adjacent to the conveyor 110 and provided to stack the trays 20 transported through the conveyor 110 in multiple stages. In the illustrated embodiment, the loading unit 122 includes a column extending vertically and a gripper 123 which vertically moves along the column. Further, a pair of columns and a pair of grippers 123 are disposed spaced apart on the left and right with the conveyor 110 therebetween. The stacking operation of the trays 20 through the loading unit 122 will be further described in detail with reference to FIGS. 2A to 2C to be described below.

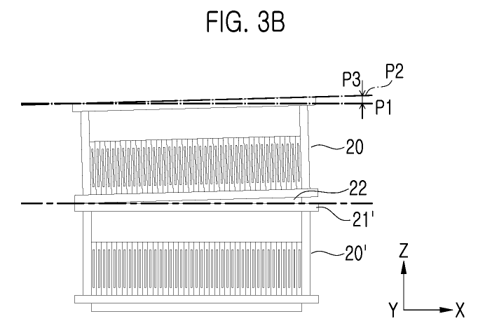

Meanwhile, in some embodiments, the secondary battery manufacturing device 100 may include a tray detector 200. The tray detector 200 may be provided to detect a stacking defect of the trays 20. A detailed configuration of the tray detector 200 will be further described with reference to FIG. 4 and the like to be described below.

FIGS. 2A to 2C are views illustrating an example of the input and stacking operations of the trays in the secondary battery manufacturing device illustrated in FIG. 1.

Referring to FIG. 2A, first, the tray 20 may be transported to a stacking position through the conveyor 110. When the tray 20 is transported to the stacking position, the tray loader 120 may advance the gripper 123 toward the tray 20 to grip the corresponding tray 20.

Referring to FIG. 2B, the gripper 123 may rise while gripping the tray 20. Accordingly, the tray 20 is lifted upward and away from the conveyor 110. Further, while the tray 20 is lifted in this manner, a new tray 20' may be supplied through the conveyor 110. The newly supplied tray 20' may be moved and disposed below the tray 20 gripped by the gripper 123.

Referring to FIG. 2C, thereafter, the gripper 123 may be lowered, and thus the lifted tray 20 may be stacked on the newly supplied tray 20'. The lifted tray 20 may be stacked on the newly supplied tray 20' while a lower second stacking guide 22 is coupled to an upper first stacking guide 21' on the newly supplied tray 20'. The tray loader 120 may be provided to stack a plurality of trays 20 and 20' in multi-stages in this way. Further, in the example, a case in which the trays 20 are stacked in two stages is exemplified, but even when the trays 20 are stacked in three or more stages, each tray 20 may be sequentially stacked in a similar manner as described above.

FIGS. 3A and 3B are drawings illustrating an example of stacking state of trays in the secondary battery manufacturing device illustrated in FIG. 1.

FIG. 3A shows a normal stacking state. Referring to FIG. 3A, the tray 20 stacked on the upper side includes a second stacking guide 22 at the lower end, and the second stacking guide 22 may be coupled to the first stacking guide 21' of the tray 20' disposed on the lower side. The first stacking guide 21' is located on the upper end of the tray 20' disposed on the lower side. In the normal state, the upper second stacking guide 22 may be appropriately aligned with the lower first stacking guide 21’. Further, an upper position P1 (height) of the upper and lower stacked trays 20 and 20' may be appropriately disposed at a set position (height).

FIG. 3B exemplifies a case in which the stacking defect occurs. Referring to FIG. 3B, in some cases, the upper and lower trays 20 and 20' may have a stacking defect during the stacking process. For example, as the first and second stacking guides 21' and 22 are coupled in a non-aligned state, the upper and lower trays 20 and 20' may have a deviation in position, posture, or the like. Alternatively, the stacking defect may occur due to foreign substances interposed between the upper and lower trays 20 and 20’ or due to various other process-related factors. When the stacking defect occurs, the upper and lower trays 20 and 20' may have a certain deviation P3 at an upper position P2 (height). For example, in the illustrated embodiment, the upper tray 20 is seated on the lower tray 20’ in a slightly tilted state facing the left side, and accordingly, the upper right end of the tray 20 protrudes slightly upward compared to the normal state. Of course, in addition to the above example, the stacking defect may occur in various forms between the upper and lower trays 20 and 20’.

When the above-described stacking defect has occurred, the upper and lower trays 20 and 20' are transported through the conveyor 110 without an appropriate coupling and support state. This may cause various safety accidents during the manufacturing process. For example, a safety accident such as a collapse of the stacking state during the transport process, interference with other adjacent equipment, or the like may be caused.

In the secondary battery manufacturing device 100 according to the embodiments of the present disclosure, the above-described stacking defect may be appropriately detected by the tray detector 200 to be described below. Further, as a notification signal or the like is provided depending on whether there is a stacking defect, the stacking defect state may be quickly corrected.

FIG. 4 is a schematic front view of the secondary battery manufacturing device illustrated in FIG. 1.

Referring to FIG. 4, in some embodiments, the secondary battery manufacturing device 100 may include: a conveyor 110 which transports trays 20 in which battery cells 10 are accommodated; a tray loader 120 which stacks the trays 20 in multiple stages; and a tray detector 200 which detects the stacking defect of the trays 20. Here, the tray detector 200 may include: a detector body 210 which comes into contact and interferes with the tray 20 in which the stacking defect has occurred to change an arrangement state; a sensor 220 which detects a change in the arrangement state of the detector body 210; and a locking pin 230 which limits the return of the detector body 210 to maintain the changed arrangement state when the arrangement state of the detector body 210 is changed.

The conveyor 110 and the tray loader 120 may be provided in the same or similar manner as described above.

The tray detector 200 may be provided to detect the stacking defect of the tray 20. In some embodiments, the tray detector 200 may be provided to interfere with the protruding portions of the trays 20 as in the above-described FIG. 3B to detect the stacking defect of the trays 20. In other words, the tray detector 200 may be provided to selectively come into contact and interfere with the tray 20 in which the stacking defect has occurred to detect the stacking defect of the tray 20.

In some embodiments, the tray detector 200 may be disposed at the rear of the loading unit 122. Here, the rear refers to the rear according to the transport direction F1 of the conveyor 110. The tray detector 200 may be provided to detect whether there is the stacking defect of the trays 20 at the rear when the trays 20 are stacked in multiple stages by the loading unit 122.

In some embodiments, the tray detector 200 may be mounted on the loader frame 121. In the illustrated embodiment, the tray detector 200 is mounted on the loader frame 121 through an installation bracket 240.

In some embodiments, a plurality of tray detectors 200 may be provided. For example, a pair of tray detectors 200 may be provided on the left and right as in the illustrated embodiment, and the pair of tray detectors 200 may be spaced apart from each other on the left and right along a left-right width direction of the tray 20. In this case, each tray detector 200 may be provided to interfere with the protruding portion of the tray 20 at each corresponding position. That is, the tray detector 200 on the left may be provided to interfere with the left protruding portion of the tray 20 and change the arrangement state, and the tray detector 200 on the right may be provided to interfere with the right protruding portion of the tray 20 and change the arrangement state.

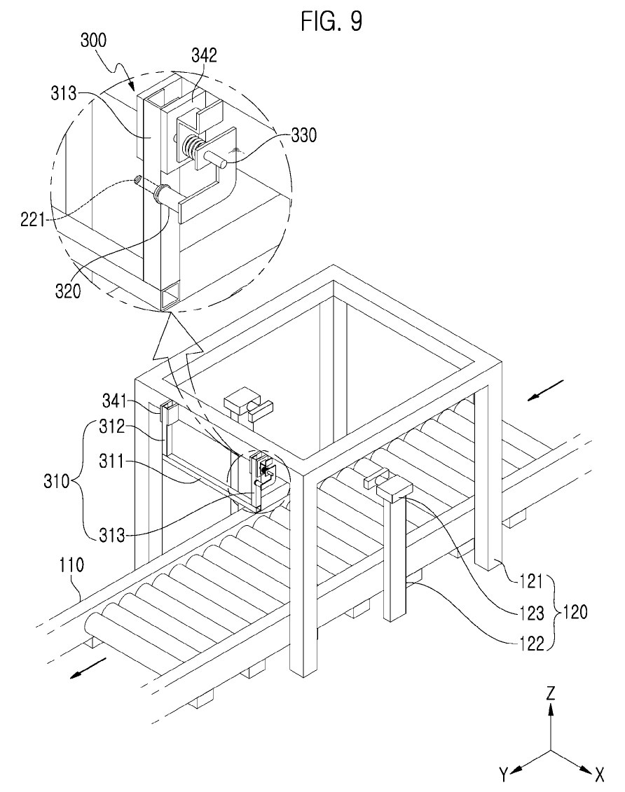

However, the number, arrangement, and the like of tray detectors 200 are not necessarily limited to the example described above. For example, the tray detector 200 may be integrated to interfere with both the left and right protruding portions as in FIG. 9 and the like to be described below. Further, in some embodiments, a pair of tray detectors 200 or a plurality of two or more tray detectors 200 may be spaced apart from each other on the left and right and/or the front and rear.

Looking at the detailed configuration of the tray detector 200, in some embodiments, the tray detector 200 may include the detector body 210. The detector body 210 may form the overall appearance of the tray detector 200. In the illustrated embodiment, the detector body 210 is exemplified in a bar shape having a certain cross-sectional shape and extending in a longitudinal direction. However, the specific shape of the detector body 210 may be modified in various ways as needed, and is not necessarily limited to the illustrated example.

In some embodiments, the detector body 210 may be provided to come into contact and interfere with the tray 20 in which the stacking defect has occurred. To this end, the detector body 210 may be disposed adjacent to an outer surface of the tray 20. For example, in the illustrated embodiment, the detector body 210 is disposed in a transverse direction, and thus a bottom surface portion is disposed adjacent to an upper surface of the tray 20. Accordingly, the detector body 210 may come into contact and interfere with the upper surface of the tray 20 depending on the stacking state of the trays 20.

In some embodiments, the detector body 210 may be provided to change the arrangement state according to the contact with the tray 20. Specifically, the detector body 210 may be disposed at a certain initial position, and provided to change the arrangement state as the tray 20 comes into contact at the initial position. In other words, the detector body 210 may be provided so that it maintains the initial position for the normally stacked tray 20 and may selectively come into contact with the tray 20 in which the stacking defect has occurred to change the arrangement state from the initial position.

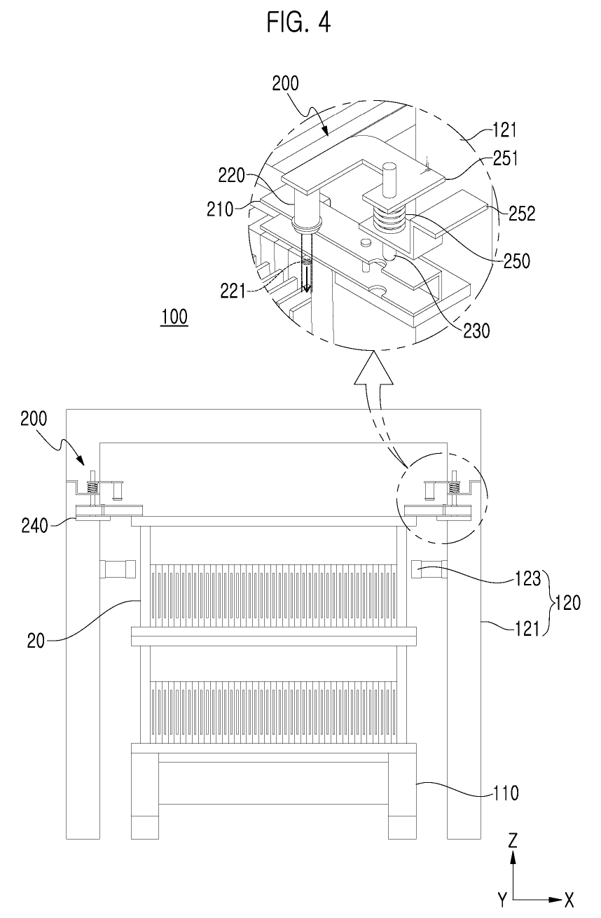

FIG. 5 is a schematic perspective view illustrating the detector body illustrated in FIG. 4 in a separated state.

Referring to FIG. 5, in some embodiments, the detector body 210 may include a hinge shaft 211. In the illustrated embodiment, the hinge shaft 211 is disposed slightly offset from the longitudinal direction center of the detector body 210 toward one end portion. The hinge shaft 211 may be supported on the installation bracket 240. Further, the detector body 210 may be provided to be rotatable around the hinge shaft 211. Accordingly, the detector body 210 may rotationally move a certain angle around the hinge shaft 211 during contact and interference with the tray 20. In some embodiments, the tray detector 200 may be provided to detect whether there is the contact and interference or the stacking defect of the tray 20 based on the rotational movement of the detector body 210.

Meanwhile, in some embodiments, the detector body 210 may include a pin-seating groove 212. The pin-seating groove 212 may be provided in a shape which is concavely recessed into the outer surface of the detector body 210 to a certain degree. In the illustrated embodiment, the pin-seating groove 212 is disposed adjacent to the hinge shaft 211 on an upper surface of the detector body 210.

In some embodiments, the pin-seating groove 212 may be disposed spaced apart from the hinge shaft 211 of the detector body 210 at a certain interval in a radial direction centered on the hinge shaft 211. In other words, the pin-seating groove 212 may be disposed between the hinge shaft 211 and one end portion of the detector body 210 (the right end portion in the drawing) based on the longitudinal direction of the detector body 210.

In some embodiments, the pin-seating groove 212 may function to guide an arrangement position of the locking pin 230 to be described below. In other words, the locking pin 230 may be disposed to be seated in the pin-seating groove 212 in a state in which the detector body 210 is disposed at the initial position. The pin-seating groove 212 and the locking pin 230 assist the detector body 210 to appropriately maintain the initial position. Further, in some embodiments, the pin-seating groove 212 and the locking pin 230 may provide a certain fixing force to the detector body 210 to prevent detection errors due to external environmental factors.

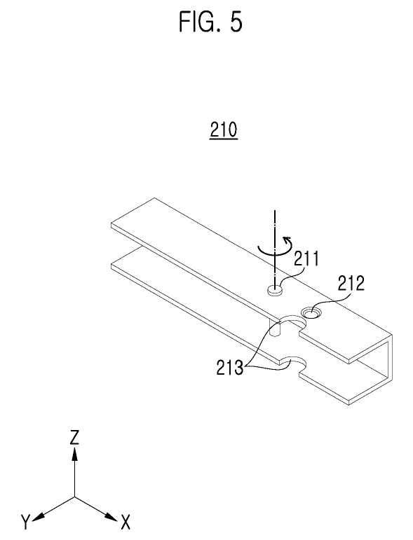

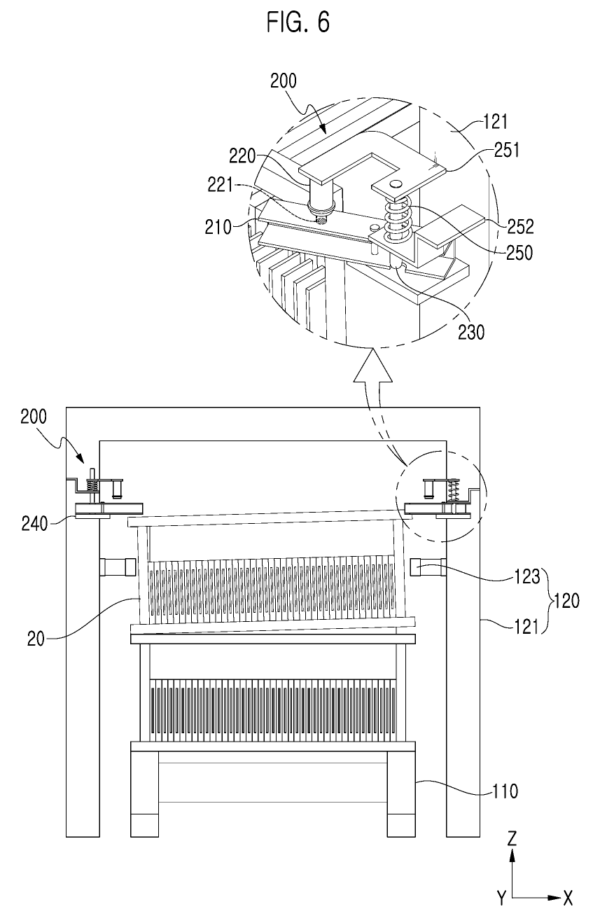

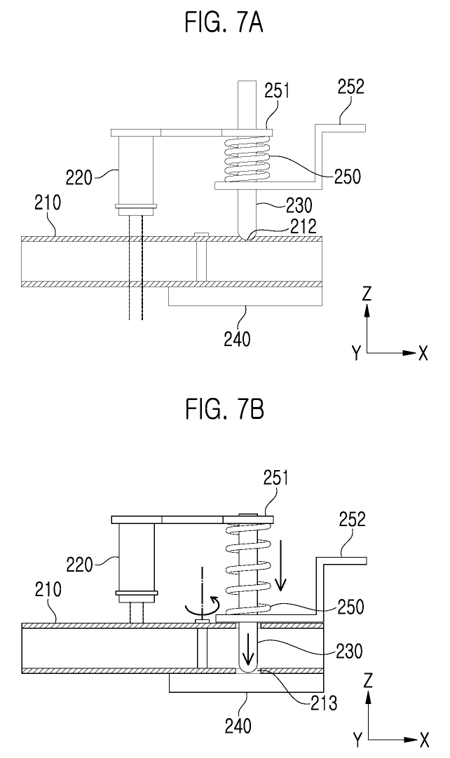

Meanwhile, in some embodiments, the detector body 210 may include a locking groove 213. The locking groove 213 may be provided adjacent to the pin-seating groove 212. Specifically, the locking groove 213 may be disposed spaced apart from the pin-seating groove 212 at a certain interval along a circumferential direction centered on the hinge shaft 211. Further, the locking groove 213 may be fastened to the locking pin 230 as the arrangement state of the detector body 210 is changed. Specifically, the locking pin 230 may be disposed to be seated in the pin-seating groove 212 in the initial state, and may be separated from the pin-seating groove 212 and fastened to the locking groove 213 according to rotation of the detector body 210. Further, the detector body 210 may be limited from returning to the initial state as the locking pin 230 is fastened to the locking groove 213. This will be further described with reference to FIGS. 6 and 7 to be described below.

In some embodiments, the locking groove 213 may be formed in the form of a groove in which one side of the detector body 210 is concavely recessed as illustrated. However, the locking groove 213 may be implemented in various forms as long as it has a form which can be appropriately fastened to the locking pin 230 to limit the rotation of the detector body 210 and is not necessarily limited to the above example.

Referring to FIG. 4 again, in some embodiments, the tray detector 200 may include the sensor 220. The sensor 220 may be provided to detect a change in the arrangement state of the detector body 210. Further, the sensor 220 may be provided to detect whether there is the stacking defect of the tray 20 through the above change.

In some embodiments, the detector body 210 may be provided to rotationally move by contact with the tray 20 as described above. In this case, the sensor 220 may be provided to detect the rotational movement of the detector body 210 and detect the stacking defect of the tray 20.

Specifically, the sensor 220 may include a detection region 221. In the illustrated embodiment, the detection region 221 is exemplified as a partial region of a lower side of the sensor 220. The sensor 220 may be provided to detect the presence or absence of an object in the detection region 221. That is, the sensor 220 may be provided to detect the presence or absence of the detector body 210 in the detection region 221. Further, in the illustrated embodiment, the sensor 220 may be disposed at a position offset from the initial position of the detector body 210. That is, the detection region 221 of the sensor 220 may be disposed spaced apart from the initial position of the detector body 210. Meanwhile, the detector body 210 may come into contact and interfere with the tray 20 and may rotationally move from the initial position to a certain degree. Accordingly, the detector body 210 may enter the detection region 221 of the sensor 220, and the sensor 220 may detect the entered detector body 210. In this way, the sensor 220 may detect the change in the arrangement state of the detector body 210 and the stacking defect of the tray 20.

In some embodiments, the above-described detection method of the sensor 220 may be implemented in reverse. That is, the detection region 221 of the sensor 220 may be disposed to correspond to the initial position of the detector body 210, and the sensor 220 may be provided to detect the stacking defect of the tray 20 through separation of the detector body 210 from the detection region 221.

The sensors 220 may include various types of sensors capable of appropriately detecting the detector body 210. In some embodiments, the sensor 220 detects a relatively easy-to-detect detector body 210 as a detection target, and thus may be provided as a relatively low-cost sensor. In some embodiments, the sensor 220 may be provided as a proximity sensor capable of detecting the presence or absence of an object in a certain detection region 221. The proximity sensor may include one or more of a magnetic proximity sensor, an optical proximity sensor, an inductive proximity sensor, a capacitive proximity sensor, an ultrasonic proximity sensor, an eddy current proximity sensor, and an infrared proximity sensor.

Meanwhile, in some embodiments, the tray detector 200 may include the locking pin 230. The locking pin 230 may be provided to limit the return of the detector body 210 to the initial position when the arrangement state of the detector body 210 is changed. Accordingly, the detector body 210 may be maintained in the changed arrangement state.

The above-described locking pin 230 allows the sensor 220 to be maintained in a state of detecting the stacking defect of the tray 20. That is, when the stacking defect occurs in the tray 20 and the arrangement state of the detector body 210 is changed, the change in the arrangement state of the detector body 210 and the stacking defect of the tray 20 may be detected by the sensor 220, and the detection state of the sensor 220 may be maintained by the locking pin 230. Accordingly, follow-up measures by a user or the like may be appropriately taken, and more reliable notifications of the stacking defect may be provided.

In some embodiments, the locking pin 230 may be provided in the form of a pin extending in the longitudinal direction. In the illustrated embodiment, since the locking pin 230 is disposed in the vertical direction, a lower end of the locking pin 230 is provided to be in contact with the upper surface of the detector body 210.

In some embodiments, the lower end of the locking pin 230 may be disposed to be seated in the pin-seating groove 212. The pin-seating groove 212 and the locking pin 230 assist the detector body 210 to appropriately maintain the initial position.

In some embodiments, the lower end of the locking pin 230 seated in the pin-seating groove 212 may be formed in a gently curved shape. For example, the lower end of the locking pin 230 may be formed in a partially spherical shape. The locking pin 230 may be appropriately separated from the pin-seating groove 212 when the detector body 210 moves due to the interference with the tray 20 while providing an appropriate fixing force to the detector body 210.

In some embodiments, the locking pin 230 may be elastically supported toward the outer surface of the detector body 210. Accordingly, the locking pin 230 may be maintained in contact with the outer surface of the detector body 210. Further, when the detector body 210 rotates, the locking pin 230 may protrude by an elastic support force and may be fastened to the locking groove 213.

Specifically, the locking pin 230 may be elastically supported by an elastic body 250. In some embodiments, the elastic body 250 may be provided as a compression coil spring. In this case, the locking pin 230 may be disposed to be accommodated inside the compression coil spring.

The elastic body 250 may be supported with an upper end fastened to a fixed bracket 251. The fixed bracket 251 may be fastened and fixed to the loader frame 121. The locking pin 230 may be movably fastened to the fixed bracket 251. That is, the locking pin 230 may be fastened to pass through the fixed bracket 251, and thus vertical movement may be guided by the fixed bracket 251.

A lower end of the elastic body 250 may be fastened to an unlock lever 252. Accordingly, the elastic body 250 may be provided to elastically support between the fixed bracket 251 and the unlock lever 252. Further, the unlock lever 252 may be fixedly coupled to the outer surface of the locking pin 230. Accordingly, the unlock lever 252 may be vertically moved along with the locking pin 230. The unlock lever 252 may be used for manipulation of the locking pin 230 by the user or the like.

In the initial state, the above-described locking pin 230 may be maintained in the state of contact with the outer surface of the detector body 210. That is, the lower end of the locking pin 230 may be disposed to be seated in the pin-seating groove 212 and elastically supported downward by the elastic body 250 to be maintained in a state of being seated in the pin-seating groove 212. Meanwhile, when the detector body 210 is rotated in the initial state, the locking pin 230 may be separated from the pin-seating groove 212 and may protrude downward by the elastic body 250. Further, the protruding locking pin 230 may be fastened to the locking groove 213 to maintain the detector body 210 in a rotating state. That is, the return of the detector body 210 may be limited by the locking pin 230.

FIG. 6 is a view illustrating an example of the operation of the tray detector illustrated in FIG. 4.

FIG. 6 exemplifies the operation of the tray detector 200 when the stacking defect occurs in the trays 20. Referring to FIG. 6, the tray 20 in which the stacking defect has occurred is transported through the conveyor 110 and approaches the tray detector 200. The operational example exemplifies a case in which the trays 20 are tilted and stacked so that right side regions of the trays 20 protrude upward. The protruding regions of the trays 20 may come into contact and interfere with the tray detector 200 on the right side as the trays 20 are transported through the conveyor 110.

The protruding regions of the trays 20 may come into contact and interfere with the detector body 210 on the right side of the tray detector 200, and accordingly, the detector body 210 may change the arrangement state while being rotated around the hinge shaft 211. That is, the detector body 210 is slightly rotated counterclockwise around the hinge shaft 211 due to interference with the tray 20.

Meanwhile, when the detector body 210 is rotated, the detector body 210 enters the detection region 221 of the sensor 220 and may be detected by the sensor 220. The sensor 220 may detect that the stacking defect has occurred in the trays 20 through detection of the detector body 210 and may provide an appropriate notification signal to the user or the like.

Meanwhile, when the detector body 210 is rotated as described above, the locking pin 230 may be separated from the pin-seating groove 212. Further, the locking pin 230 may be fastened to the locking groove 213 while protruding downward to a certain degree by the elastic body 250. Accordingly, the return of the detector body 210 to the initial state may be appropriately limited, and the sensor 220 may continuously maintain the detection state. In some embodiments, maintaining the detection state may function as a means which allows the user or the like to more reliably recognize the stacking defect state and take appropriate follow-up measures.

Meanwhile, when the above-described stacking defect is appropriately recognized and followed-up measures are taken by the user or the like, the tray detector 200 may return to the initial state. In some embodiments, the return to the initial state may be directly performed by the user or the like. This method may function as a means which forces the user or the like to directly check whether the stacking defect is resolved on-site. The user or the like may return the tray detector 200 to the initial state by separating the locking pin 230 from the locking groove 213 through the unlock lever 252 and rotating the detector body 210 back to the initial position.

FIG. 7A is a schematic cross-sectional view illustrating the tray detector in the initial state. FIG. 7B is a schematic cross-sectional view illustrating the tray detector in a state in which the detector body is rotated.

Referring to FIG. 7A, in the initial state, the tray detector 200 may be disposed in a state in which the lower end of the locking pin 230 is in contact with and supported on the outer surface of the detector body 210. In this state, the lower end of the locking pin 230 may be seated in the pin-seating groove 212 and maintain its position.

Referring to FIG. 7B, when the detector body 210 is rotated in the initial state due to contact and interference with the tray 20, the locking pin 230 may be separated from the pin-seating groove 212 and fastened to the locking groove 213. The locking pin 230 may be inserted into the locking groove 213 by protruding downward to a certain degree by the elastic body 250. In some embodiments, the unlock lever 252 at a lower end of the locking pin 230 may be supported by coming into contact with the outer surface of the detector body 210 to function as a means which appropriately limits a movement amount of the locking pin 230.

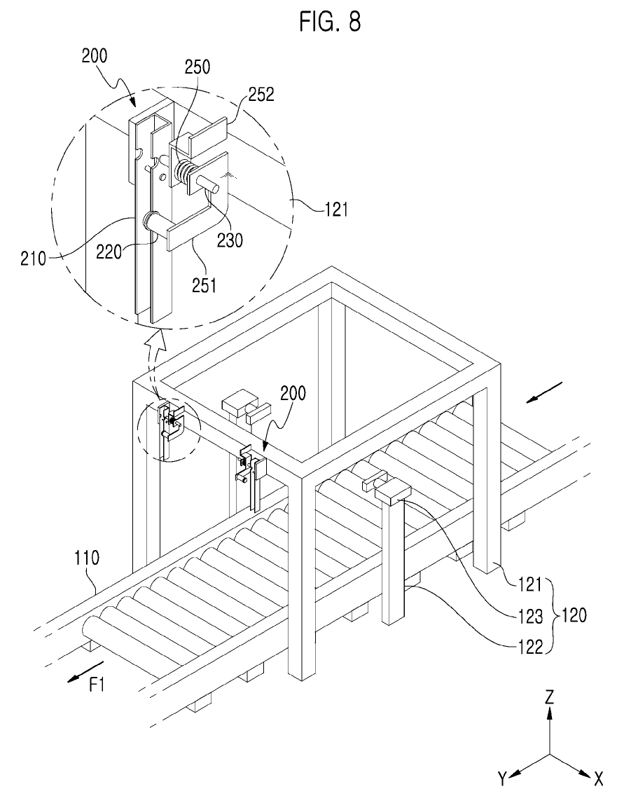

FIG. 8 is a schematic perspective view illustrating another installation form of the tray detector illustrated in FIG. 4.

In the above-described tray detector 200, the hinge shaft 211 of the detector body 210 may be disposed orthogonal to the transport direction F1 of the conveyor 110, or the hinge shaft 211 of the detector body 210 may be disposed parallel to the transport direction F1 of the conveyor 110. FIG. 4 illustrates an example of the former, and FIG. 8 illustrates an example of the latter.

Specifically, referring to FIG. 8, in some embodiments, the tray detector 200 may be mounted on an upper end of the loader frame 121 so that the hinge shaft 211 is disposed parallel to the transport direction F1. Further, a pair of tray detectors 200 may be provided on the left and right and may be disposed spaced apart on the left and right on the upper end of the loader frame 121. Each tray detector 200 may be provided to detect whether there is the stacking defect of the tray 20 at each corresponding position. Only an arrangement position and direction of the tray detector 200 are partially changed, and generally, the tray detector 200 may operate similarly to the above-described tray detector 200.

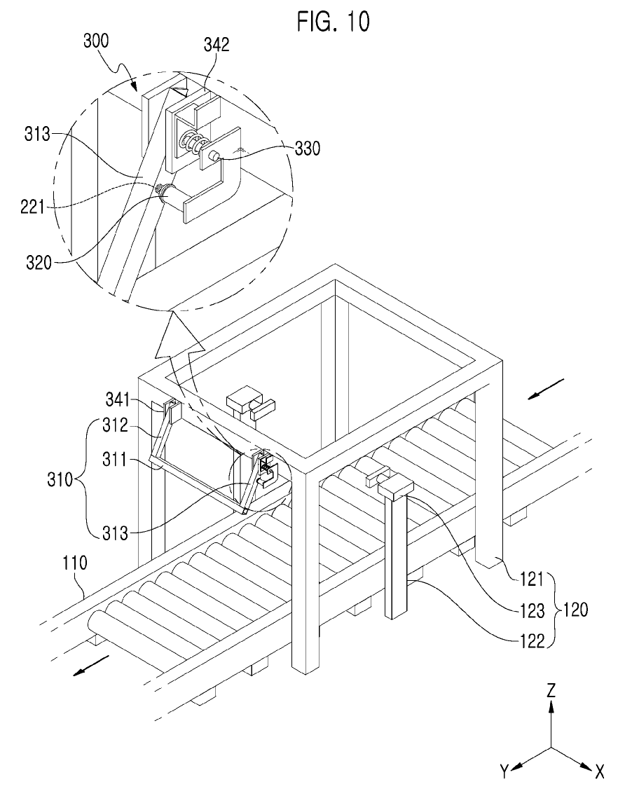

FIG. 9 is a schematic perspective view illustrating another embodiment of a tray detector illustrated in FIG. 4. FIG. 10 is a view illustrating an example of the operation of the tray detector illustrated in FIG. 9.

Referring to FIGS. 9 and 10, in some embodiments, a tray detector 300 may be provided to interfere with both left and right side protruding portions of the tray 20.

Specifically, in some embodiments, the tray detector 300 may include a detector body 310, and the detector body 310 may include an extending bracket 311 extending along a left-right width direction of the tray 20. The extending bracket 311 may be formed to extend with a left-right width corresponding to the left-right width of the tray 20, or with a left-right width that is a certain amount larger than the left-right width of the tray 20. Accordingly, the extending bracket 311 may interfere with both the left and right side protruding portions of the tray 20.

The extending bracket 311 may be rotatably fastened to the loader frame 121 through first and second link arms 312 and 313. The first link arm 312 may extend from one end portion of the extending bracket 311 toward the loader frame 121. Further, the first link arm 312 may be rotatably fastened to a first installation bracket 341 fastened to the loader frame 121 around the hinge shaft 211. Similarly, the second link arm 313 may extend from an opposite end portion of the extending bracket 311 toward the loader frame 121 and may be rotatably fastened to a second installation bracket 240 around the hinge shaft 211. The hinge shaft 211 may be provided as a shaft in the left-right direction.

In the above-described tray detector 300, the extending bracket 311 may rotate as the tray 20 comes into contact with a left or right region of the extending bracket 311. Accordingly, one tray detector 300 may detect the stacking defect on both the left and right sides of the tray 20.

A sensor 320 may be provided to detect the rotation of the above-described extending bracket 311. For example, the sensor 320 may be disposed adjacent to the first link arm 312 or the second link arm 313 to detect the rotation of the extending bracket 311 or the stacking defect of the tray 20 through the presence or absence of the first link arm 312 or the second link arm 313 in the detection region. In some embodiments, the sensor 320 may be disposed on only one of the first link arm 312 and the second link arm 313.

A locking pin 330 may be provided to limit the return of the detector body 310 when the detector body 310 is rotated. Accordingly, the detector body 310 may be maintained in a rotated state, and the sensor 320 may be maintained in a state of detecting the stacking defect. In some embodiments, the locking pin 330 may be disposed on the first installation bracket 341 or the second installation bracket 240. The illustrated embodiment exemplifies a case in which the locking pin 330 is disposed on the second installation bracket 240. In some embodiments, the locking pin 330 may be disposed on only one of the first installation bracket 341 and the second installation bracket 240.

In the illustrated embodiment, an access hole may be provided in the second installation bracket 240 so that the locking pin 330 may access the second link arm 313. The locking pin 330 may access the second link arm 313 through the access hole. Further, the second link arm 313 may include a pin-seating groove which guides an initial position of the locking pin 330, and a locking groove fastened to the locking pin 330 when the detector body 310 rotates. Since the pin-seating groove and the locking groove are similar to those described above with reference to FIG. 4 or the like, a more detailed description thereof will be omitted.

Meanwhile, according to another aspect of the present disclosure, a tray detector which detects a stacking defect of a tray may be provided. In some embodiments, the tray detector may include: a detector body which comes into contact and interferes with the tray in which the stacking defect has occurred to change the arrangement state; a sensor which detects a change in the arrangement state of the detector body; and a locking pin which limits the return of the detector body when the arrangement state of the detector body is changed and maintains the changed arrangement state.

In some embodiments, the detector body may be provided to come into contact and interfere with the tray in which the stacking defect has occurred to rotationally move a certain angle around a hinge shaft. Further, the sensor may be provided to detect the rotationally moved detector body and detect the stacking defect of the tray. In addition, the locking pin may be provided to be elastically supported toward an outer surface of the detector body and protrude in an elastically supported direction according to the rotational movement of the detector body to limit the return of the detector body.

Since the above-described tray detector is similar to those described above through FIGS. 4 to 10, a more detailed description will be omitted.

As described above, the embodiments of the present disclosure may provide a secondary battery manufacturing device.

Further, some embodiments of the disclosure may be provided to stack trays in multiple stages and transport the trays through a tray loader.

In addition, some embodiments of the present disclosure may appropriately detect whether there is a stacking defect of the tray through a tray detector. Accordingly, safety accidents due to the stacking defect may be prevented in advance.

Further, in some embodiments of the present disclosure, when the stacking defect of the tray is detected, since the return of a detector body is limited by a locking pin, a detection state may be maintained. Accordingly, a user or the like may more reliably recognize the stacking defect of the tray. Further, since appropriate follow-up measures are forced to be taken by the user or the like, safety accidents due to the stacking defect may be more reliably prevented.

In addition, in some embodiments of the present disclosure, whether there is the stacking defect of the tray may be detected through the sensor which detects the detector body which comes into contact and interferes with the tray and the arrangement state of the detector body. This method may be constructed at relatively low costs by allowing a relatively low-cost sensor to be used.

Embodiments of the present disclosure can provide a secondary battery manufacturing device.

Some embodiments of the present disclosure can provide a secondary battery manufacturing device capable of stacking trays in which battery cells are accommodated in multiple stages and transporting the trays.

Further, some embodiments of the present disclosure can provide a secondary battery manufacturing device capable of preventing safety accidents due to a stacking defect of trays.

In addition, some embodiments of the present disclosure can provide a secondary battery manufacturing device capable of more reliably informing a user or the like of a stacking defect state of trays.

In addition, some embodiments of the present disclosure can provide a secondary battery manufacturing device which can be constructed at relatively low costs while appropriately detecting a stacking defect state of trays.

The above description is only an example to which the principle of the present disclosure is applied, and other configurations may be further included without departing from the scope of the present disclosure.

Although the embodiments of the present disclosure have been described above, those skilled in the art may variously modify or change the present disclosure by adding, changing, deleting, or adding components without departing from the technical spirit of the present disclosure described in the claims, and this is also included in the scope of the present disclosure.

What is claimed is:

1. A secondary battery manufacturing device comprising:
a conveyor that transports trays in which battery cells are accommodated;
a tray loader that stacks a plurality of trays in multiple stages; and
a tray detector that detects a stacking defect of the trays,
wherein the tray detector includes:
a detector body that comes into contact and interferes with the tray in which the stacking defect has occurred to change an arrangement state;
a sensor that detects a change in the arrangement state of the detector body; and
a locking pin that limits the return of the detector body when the arrangement state of the detector body is changed and maintains the changed arrangement state.

2. The secondary battery manufacturing device of claim 1, wherein a deviation occurs in heights of upper ends of the trays compared to a normal state when the stacking defect occurs, and
the detector body selectively comes into contact and interferes with the tray according to the deviation to change the arrangement state.

3. The secondary battery manufacturing device of claim 1, wherein the tray loader includes:
a loader frame in which the conveyor is disposed in an inner region; and
a loading unit that is disposed adjacent to the conveyor and stacks the trays in multiple stages through a gripper.

4. The secondary battery manufacturing device of claim 1, wherein the detector body is formed to come into contact and interfere with the tray in which the stacking defect has occurred to rotationally move a certain angle around a hinge shaft.

5. The secondary battery manufacturing device of claim 4, wherein the sensor is formed to detect the rotationally moved detector body and detect the stacking defect of the tray.

6. The secondary battery manufacturing device of claim 4, wherein, in the tray detector, the hinge shaft is disposed orthogonal to a transport direction of the conveyor, or the hinge shaft is disposed parallel to the transport direction of the conveyor.

7. The secondary battery manufacturing device of claim 1, wherein the detector body includes a pin-seating groove in which an end portion of the locking pin is disposed to be elastically seated in an initial state.

8. The secondary battery manufacturing device of claim 7, wherein the pin-seating groove is spaced apart from a hinge shaft of the detector body at a certain interval in a radial direction centered on the hinge shaft.

9. The secondary battery manufacturing device of claim 1, wherein the detector body includes a locking groove fastened to the locking pin according to the change in the arrangement state of the detector body.

10. The secondary battery manufacturing device of claim 1, wherein the locking pin is elastically supported toward an outer surface of the detector body and protrudes in an elastically supported direction to limit the return of the detector body according to the change in the arrangement state of the detector body.

11. The secondary battery manufacturing device of claim 1, wherein the tray detector includes an elastic body that elastically supports the locking pin toward an outer surface of the detector body, and
the elastic body includes a compression coil spring that accommodates the locking pin therein.

12. The secondary battery manufacturing device of claim 11, wherein, in the elastic body, one end portion is supported on an unlock lever and an opposite end portion corresponding to the one end portion is supported on a fixed bracket,
the unlock lever is fixedly coupled to the locking pin and elastically supported by the elastic body along with the locking pin, and
the locking pin is movably fastened to the fixed bracket along an operating direction.

13. The secondary battery manufacturing device of claim 1, wherein the sensor includes a proximity sensor formed to detect whether the detector body is present in a detection region, and
the proximity sensor includes one or more of a magnetic proximity sensor, an optical proximity sensor, an inductive proximity sensor, a capacitive proximity sensor, an ultrasonic proximity sensor, an eddy current proximity sensor, and an infrared proximity sensor.

14. The secondary battery manufacturing device of claim 1, wherein a pair of tray detectors are provided, and
the pair of tray detectors are formed to be disposed spaced apart along a left-right width direction of the tray, and come into contact and interfere with the tray in which the stacking defect has occurred at each corresponding position.

15. The secondary battery manufacturing device of claim 1, wherein the detector body includes an extending bracket formed to extend along a left-right width direction of the tray, and
the extending bracket is formed to come into contact and interfere with the tray in which the stacking defect has occurred to rotationally move the detector body around a hinge shaft in a left-right direction.

16. The secondary battery manufacturing device of claim 1, wherein the detector body includes:
an extending bracket formed to extend along a left-right width direction of the tray;
a first link arm extending from one end portion of the extending bracket and rotationally movably fastened to a first installation bracket around a hinge shaft; and
a second link arm extending from an opposite end portion of the extending bracket and rotationally movably fastened to a second installation bracket around the hinge shaft.

17. The secondary battery manufacturing device of claim 16, wherein, when the first and second link arms are rotationally moved and thus the arrangement state of the detector body is changed, the locking pin is formed to be fastened to one of the first and second link arms to limit the return of the detector body.

18. A tray detector of a secondary battery manufacturing device, comprising:
a detector body that comes into contact and interferes with a tray in which a stacking defect has occurred to change an arrangement state;
a sensor that detects a change in the arrangement state of the detector body; and
a locking pin that limits the return of the detector body when the arrangement state of the detector body is changed and maintains the changed arrangement state.

19. The tray detector of claim 18, wherein the detector body is formed to come into contact and interfere with the tray in which the stacking defect has occurred to rotationally move a certain angle around a hinge shaft,
the sensor is formed to detect the rotationally moved detector body and detect the stacking defect of the tray, and
the locking pin is elastically supported toward an outer surface of the detector body and protrudes in an elastically supported direction according to the rotational movement of the detector body to limit the return of the detector body.
